(19) United States
(12) Patent Application Publication
(10) Pub. No.: US 2012/0055193 A1
(43) Pub. Date: Mar. 8, 2012

(54) MOTOR-DRIVEN COMPRESSOR

(75) Inventor: Hiroshi FUKASAKU, Aichi-ken (JP)

(73) Assignee: KABUSHIKI KAISHA TOYOTA JIDOSHOKKI, Aichi-ken (JP)

(21) Appl. No.: 13/219,876

(22) Filed: Aug. 29, 2011

(30) Foreign Application Priority Data
Sep. 6, 2010 (JP) 2010-199282

(51) Int. Cl. F25B 1/00; F25B 41/00; H02K 5/128

(52) U.S. Cl. 62/468; 310/86; 62/467

(57) ABSTRACT

The motor-driven compressor includes a housing, a compression mechanism, a rotary shaft and an electric motor all disposed in the housing, and a resin film. The housing has a suction port and a discharge port. The compression mechanism is adapted to compress refrigerant drawn into the housing through the suction port and to discharge the compressed refrigerant out of the housing through the discharge port. The electric motor is adapted to rotate the rotary shaft to drive the compression mechanism. The electric motor has a rotor fixed on the rotary shaft and a stator supported by the housing. The rotor has a rotor body, a permanent magnet and an end plate. The rotor body has a magnet hole in which the permanent magnet is inserted. The end plate closes an opening of the magnet hole. The resin film coats an outer surface of the rotor.

### BACKGROUND OF THE INVENTION

The present invention relates to a motor-driven compressor for use in a refrigeration system.

Motor-driven compressor for use in a refrigeration system such as vehicle-mounted air conditioner has in the housing thereof an electric motor that drives the compression mechanism of the compressor. The housing of the compressor forms a refrigerant circulation path through which refrigerant circulates and the electric motor has therein a permanent magnet such as ferrite magnet or rare-earth magnet. Thus, the permanent magnet is exposed to an environment where the permanent magnet is contactable with the refrigerant and lubricating oil circulating through the refrigerant circulation path of the refrigeration system.

Water or acid may enter the refrigerant circulation path of the refrigeration system, for example, due to the aged deterioration of refrigerant and lubricating oil and also depending on the environment under which refrigerant and lubricating oil are used. A permanent magnet that is exposed to contact with water or acid circulating with refrigerant and lubricating oil is deteriorative. To solve such problem, Japanese Patent Application Publication No. 2009-225636 proposes forming a protective film on the surface of the permanent magnet incorporated in the electric motor of the motor-driven compressor for improving the corrosion resistance of the permanent magnet.

The use of the protective film is effective in preventing the deterioration of the permanent magnet. However, if the protective film has any damage, the effect of protection by the film is reduced. A permanent magnet that reacts with water, acid, or hydrogen derived from water or acid and becomes brittle may be reduced to powder. Magnet powder that is released from the rotor moves through the refrigerant circulation path with refrigerant and lubricating oil, which may cause a short circuit and any other problem.

The motor-driven compressor may improve its reliability by using any mechanism against the corrosion of the permanent magnet instead of or in addition to the protective film. The reliability may be further improved by any mechanism that retains powdered permanent magnet in the rotor and allows the powdered magnet to function as a permanent magnet.

The present invention is directed to a motor-driven compressor that reduces deterioration of permanent magnet incorporated in an electric motor of the compressor and hence improves the reliability of the compressor.

### SUMMARY OF THE INVENTION

In accordance with an aspect of the present invention, the motor-driven compressor includes a housing, a compression mechanism, a rotary shaft, an electric motor and a resin film. The housing has a suction port and a discharge port. The compression mechanism is disposed in the housing and adapted to compress refrigerant drawn into the housing through the suction port and to discharge the compressed refrigerant out of the housing through the discharge port. The rotary shaft is disposed in the housing. The electric motor is disposed in the housing. The electric motor is adapted to rotate the rotary shaft to drive the compression mechanism. The electric motor has a rotor fixed on the rotary shaft and a stator supported by the housing. The rotor has a rotor body, a permanent magnet and an end plate. The rotor body has a magnet hole in which the permanent magnet is inserted. The end plate closes an opening of the magnet hole. The resin film coats an outer surface of the rotor.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently preferred embodiments together with the accompanying drawings in which:

FIG. 1 is a partially cross sectional view showing a motor-driven compressor according to a first example of the present invention;

FIG. 2 is an exploded perspective view showing a rotor of the motor-driven compressor of FIG. 1;

FIG. 3 is a perspective view showing the rotor of the motor-driven compressor of FIG. 1 being coated with resin film by spraying;

FIG. 4 is a schematic view showing a vehicle-mounted air conditioner according to the first example of the present invention;

FIG. 5 is an end view showing a rotor body according to a second example of the present invention, wherein permanent magnets are yet to be inserted in the rotor body;

FIG. 6 is an end view showing the rotor body of FIG. 5, wherein the permanent magnets have been inserted in the rotor body;

FIG. 7 is an illustration showing a method for filling expanded holes of the magnet holes in the rotor body of FIG. 6 with fixing resin; and

FIG. 8 is an illustration showing one of the permanent magnets fixed by the fixing resin in the rotor body of FIG. 6.

### DETAILED DESCRIPTION OF THE EMBODIMENTS

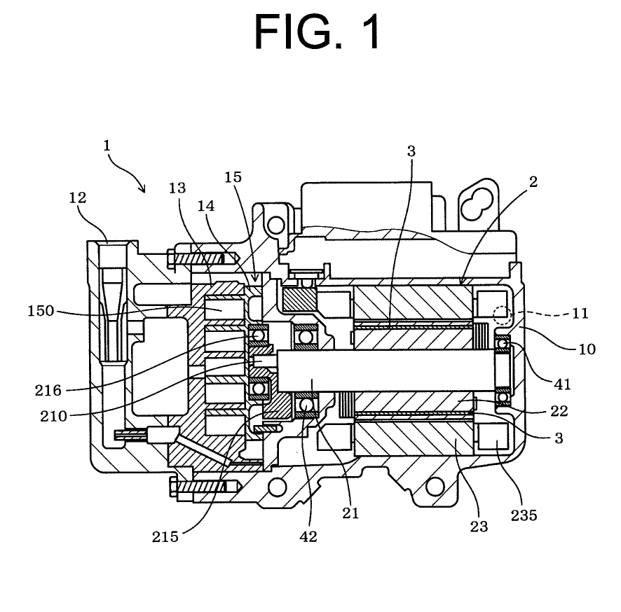

The following will describe the motor-driven compressor according to the first example of the present invention with reference to FIGS. 1 through 4. Referring to FIG. 1, the motor-driven compressor 1 includes a housing 10, a compression mechanism 15, a rotary shaft 21 and an electric motor 2 all disposed in the housing 10. The housing 10 has therein a suction port 11 and a discharge port 12. The compression mechanism 15 is adapted to compress refrigerant drawn into the housing 10 through the suction port 11 and to discharge the compressed refrigerant out of the housing 10 through the discharge port 12. The electric motor 2 rotates the rotary shaft 21 thereby to drive the compression mechanism 15.

The compression mechanism 15 has a fixed scroll member 13 fixed in the housing 10 and a moving scroll member 14 disposed in facing relation to the fixed scroll member 13. The fixed scroll member 13 and the moving scroll member 14 have therebetween a plurality of compression chambers 150 whose volumes are variable for compressing refrigerant. The moving scroll member 14 is connected to an eccentric pin 210 of the rotary shaft 21 via a bearing 216 and an eccentric bushing 215 so as to make an orbital motion in accordance with the rotation of the rotary shaft 21 thereby to vary the volumes of the compression chambers 150.

The electric motor 2 has a rotor 22 and a stator 23 disposed surrounding the rotor 22. The rotor 22 has therethrough a central hole 229 in which the rotary shaft 21 is fixed. The rotary shaft 21 projects at the opposite ends thereof from the rotor 22 and is rotatably supported at the opposite ends by bearings 41 and 42 in the housing 10, respectively. The stator 23 is supported by the housing 10 and provided with a coil 235. When the coil 235 is energized, the rotor 22 having therein a plurality of permanent magnets 3 is rotated. In the present example, the rotor 22 has four permanent magnets 3.

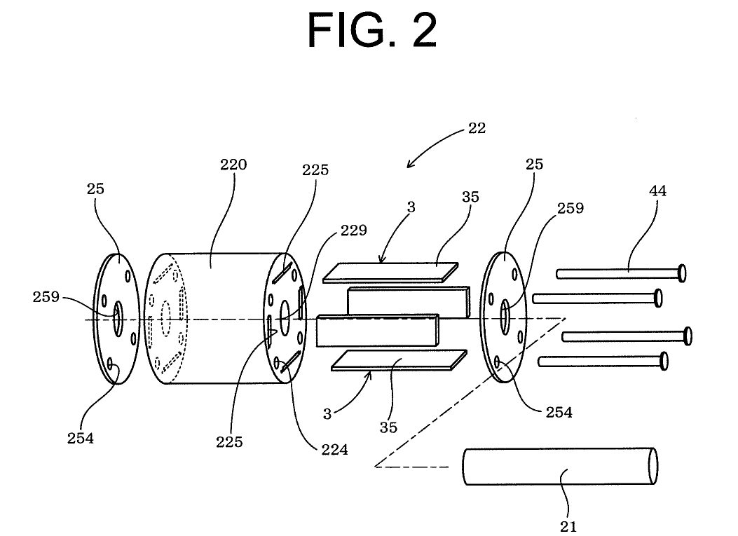

Referring to FIG. 2, the rotor 22 is formed of a plurality of magnetic steel plates laminated together into a cylinder shape. The rotor 22 has a rotor body 220 through which a plurality of magnet holes 225 are formed extending axially and a pair of end plates 25 disposed at the opposite ends in the axial direction of the rotor body 220. The paired end plates 25 close the magnet holes 225.

Each permanent magnet 3 is inserted in the magnet hole 225. The permanent magnet 3 has on the surface thereof a protective film 35 that improves the corrosion resistance of the permanent magnet 3. The protective film 35 has a chemical adsorption film. A known neodymium magnet (or rare-earth magnet) having neodymium (Nd), iron (Fe) and boron (B) as the major components is used as the permanent magnet 3.

Although a film made of a non-magnetic metal or any other protective films are usable as the protective film 35, the chemical adsorption film is used in the present example. After the surface of the permanent magnet 3 is cleaned by removing foreign substance from the surface of the permanent magnet 3, a film forming that forms the chemical adsorption film is performed.

The film forming is accomplished by bringing the permanent magnet 3 into contact with film forming solution that is alkaline aqueous solution whose pH is 8 to 10 and then drying. More specifically, the film forming solution is prepared so that the pH becomes about 8 by adding three weight percentages (wt %) of triethanolamine and one weight percentage (wt %) of polyoxyalkylene alkyl ether that serves as a surfactant to one liter of water.

Then, the film forming solution is heated to about 60 degrees Celsius (° C.) and the permanent magnet 3 is immersed in the heated film forming solution for three minutes. The permanent magnet 3 is removed from the alkaline aqueous solution and kept in an oven under an air atmosphere of about 100° C. for sixty minutes. The permanent magnet 3 is removed from the oven and left as it is until its temperature reaches an ordinary temperature. Thus, the chemical adsorption film containing an amino group is formed on the surface of the permanent magnet 3. The resulting chemical adsorption film has a molecular level thickness.

After the chemical adsorption film has been formed, the permanent magnets 3 are inserted in the respective magnet holes 225 in the rotor body 220, as indicated in FIG. 2. With the end plates 25 disposed in place on the opposite ends of the rotor body 220, rivets 44 are inserted through rivet holes 224, 254 of the rotor body 220 and the end plates 25, respectively, and one end of each rivet 44 (or the left end as seen in FIG. 2) is crimped thereby to fix the end plates 25 to the rotor body 220. Thus, the rotor 22 is completed. In addition, the rotary shaft 21 is inserted through the central hole 229 of the rotor body 220 and the central holes 259 of the end plates 25 and fixed.

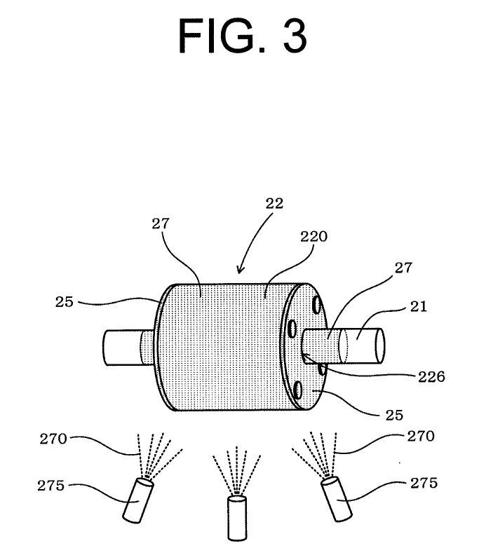

In the present example, the entire outer surface of the rotor 22 is then coated with film made of resin or resin film 27 as shown in FIG. 3. The resin film 27 is formed by coating 270 sprayed by spray units 275. Fluorine-series resin is used as the resin film 27. The resin film 27 is formed so as to coat not only the rotor 22 but also part of the rotary shaft 21 and the visible boundaries 226 between the rotary shaft 21 and the rotor 22.

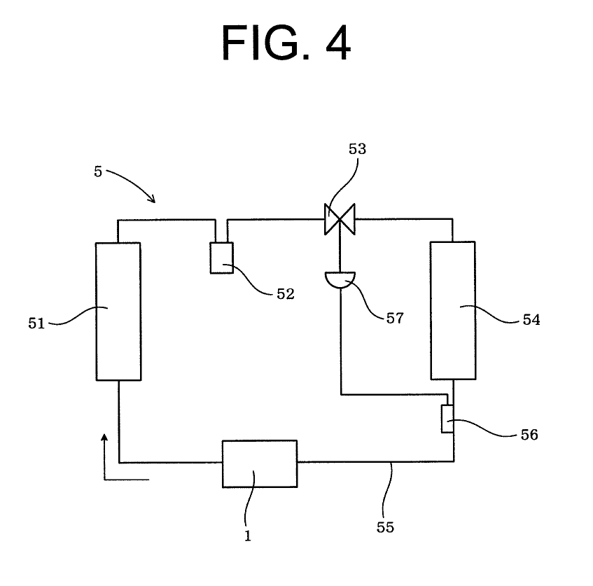

In the present example, the motor-driven compressor 1 is used for a vehicle-mounted air conditioner 5, as shown in FIG. 4. The air conditioner 5 includes a condenser 51, a receiver 52, an expansion valve 53 and an evaporator 54. The compressor 1, the condenser 51, the receiver 52, the expansion valve 53 and the evaporator 54 are connected in this order in the refrigerant circulation path 55 of the air conditioner 5. The expansion valve 53 is adjusted to change its opening by a controller 57 in accordance with the refrigerant temperature measured by a temperature sensor 56 located downstream of the evaporator 54.

The receiver 52 separates the refrigerant into vapor and liquid and transfers only the liquid refrigerant to the expansion valve 53. In addition, the receiver 52 removes water contained in the refrigerant by adsorption agent (not shown) provided in the receiver 52. The refrigerant circulation path 55, or the motor-driven compressor 1, is filled sealingly with 2,3,3,3-tetrafluoroprop-1-ene (CF₃—CF═CH₂) as a refrigerant and polyolester as a lubricating oil, respectively. Nonmetallic resin duct is used in the part of the duct forming the refrigerant circulation path 55.

When the air conditioner 5 is operated for a long period of time, water may permeate through the resin duct forming a part of the refrigerant circulation path 55 and gradually enters the refrigerant circulation path 55. In addition, refrigerant or lubricating oil may change its properties by the reaction with water thereby to produce acid.

As described above, the rotor 22 of the motor-driven compressor 1 of the present example includes the rotor body 220 having therethrough the magnet holes 225, the permanent magnets 3 inserted in the magnet holes 225, and the end plates 25 closing the openings of the magnet holes 225. In addition, the entire outer surface of the rotor 22 is coated with the resin film 27.

That is, the openings of the magnet holes 225 having therein the permanent magnets 3 are closed by the end plates 25, so that the magnet holes 225 are tentatively closed. Thus, with the exception that water or acid permeates through minute opening present in the rotor body 220 or minute gap between the rotor body 220 and the end plates 25, direct ingress of water or acid into the magnet holes 225 with refrigerant and lubricating oil is prevented.

In addition, the resin film 27 that coats the entire outer surface of the rotor 22 prevents water or acid from permeating through the above minute opening or gap with refrigerant and lubricating oil. Therefore, the ingress of water or acid into the magnet holes 225 is prevented and the deterioration of the permanent magnet 3 is prevented, accordingly.

If the permanent magnet 3 becomes brittle and is reduced to powder by chemical reaction with water, acid, or hydrogen derived therefrom, the closed structure where the rotor body 220 and the end plates 25 are combined together and an additional closed structure where the resin film 27 coats the minute opening and the minute gap cooperate to prevent the magnet powder from being released from the rotor 22.

Furthermore, the protective film 35 is formed on the surface of the permanent magnet 3, which improves remarkably the durability of the permanent magnet 3 itself. Therefore, the above effects are further enhanced.

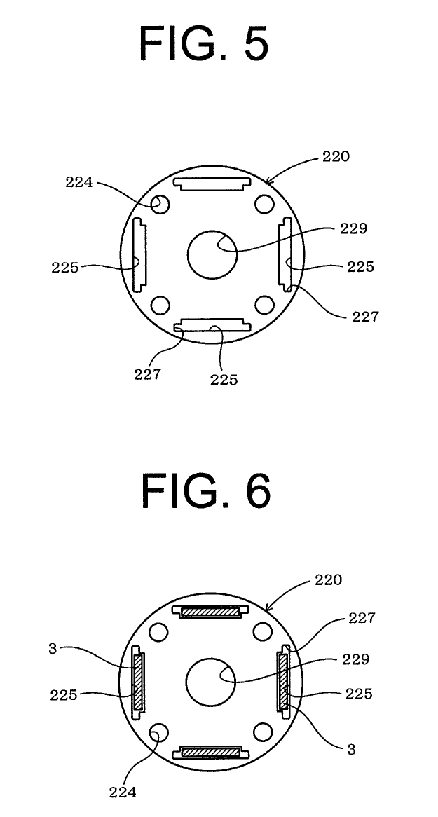

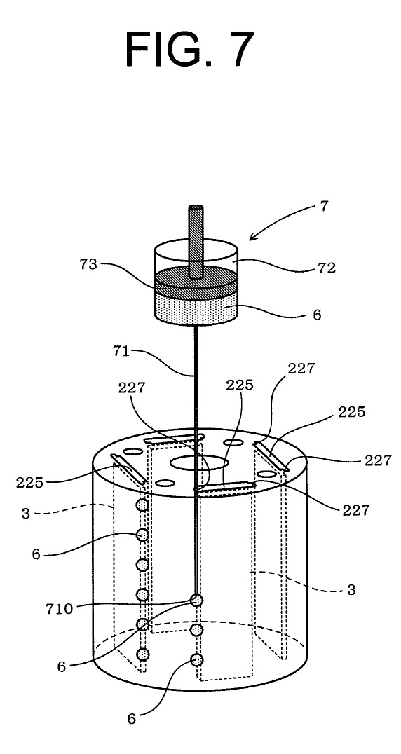

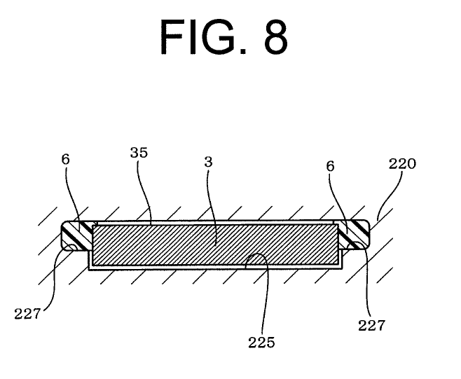

The following will describe the motor-driven compressor according to the second example of the present invention with reference to FIGS. 5 through 8. In the present example, the rotor 22 of the first example is further improved. That is, in the present example, at least part of gap between the permanent magnet 3 and the wall of the magnet hole 225 is filled with fixing resin 6 for fixing the permanent magnet 3 to the wall of the magnet hole 225 as shown in FIGS. 7 and 8.

As described in the first example, each permanent magnet 3 having the chemical adsorption protective film 35 is inserted in the magnet hole 225. As shown in FIG. 5, each magnet hole 225 has a generally rectangular main hole corresponding in shape to the contour of the permanent magnet 3 and a pair of expanded holes 227 each expanded outward from part of the short side of the rectangular main hole. Each expanded hole 227 extends axially through the rotor body 220. In the state where each permanent magnet 3 is inserted in place in the magnet hole 225, as shown in FIG. 6, part of the opposite sides of the permanent magnet 3 is positioned in facing relation to the paired expanded holes 227. In the present example, each expanded hole 227 is filled with the fixing resin 6.

Although various methods may be used for filling the expanded holes 227 with the fixing resin 6, in the present example, a syringe-like resin filling device 7 having a needle member 71 with an injection hole 710 at the distal end thereof is used, as shown in FIG. 7. The resin filling device 7 has a cylindrical member 72 whose interior communicates with that of the needle member 71 and a piston member 73 that pushes the fixing resin 6 out of the cylindrical member 72.

Resin filling operation is performed by inserting the needle member 71 of the resin filling device 7 into the expanded holes 227 of the magnet hole 225 and then injecting a proper amount of the fixing resin 6 into the expanded holes 227, as shown in FIG. 7. In the present example, the fixing resin 6 is not filled in each expanded hole 227 throughout its axial length, but partially filled in the expanded hole 227 at locations spaced axially. In order that all the permanent magnets 3 are fixed at the opposite ends in the width direction thereof, the fixing resin 6 is filled in all the expanded holes 227. Epoxy-series resin is used as the fixing resin 6. It is noted that although in the present example the fixing resin 6 is partially filled in the expanded hole 227 at locations spaced axially, the fixing resin 6 may be filled in the expanded hole 227 throughout the axial length. The rest of the structure of the motor-driven compressor of the second example is substantially the same as that of the first example.

In the present example, as described above, at least part of the gap between the permanent magnet 3 and the wall of the magnet hole 225 is filled with the fixing resin 6 after the protective film 35 is formed on the surface of the permanent magnet 3 incorporated in the rotor 22. By so doing, if the permanent magnet 3 in the rotor 22 is urged to move relative to the rotor body 220 for any reason while the motor-driven compressor 1 is in operation, the permanent magnet 3 is prevented from moving by the fixing resin 6 present in each expanded hole 227. Thus, the protective film 35 on the surface of the permanent magnet 3 is prevented from being damaged, so that the deterioration of the permanent magnet 3 is prevented and the lifetime of the permanent magnet 3 is increased, accordingly.

The improved durability of the permanent magnet 3 together with the effect obtained by the structure of the first example provides effective measures against the circumstance under which the permanent magnet 3 is deteriorative and the deterioration of the permanent magnet 3, and also a measure against the permanent magnet 3 that has been deteriorated. Thus, the second example provides the motor-driven compressor 1 with a high reliability.

In the motor-driven compressor of the present invention, it is preferred that the resin film coats also the boundary between the rotor and the rotary shaft. In the motor-driven compressor wherein the resin film coats such boundary, the effect of preventing the ingress of water or acid into the rotor is enhanced.

In the motor-driven compressor of the present invention, it is preferred that the resin film should preferably be flexible. If the permanent magnet becomes brittle and expands, the volume of the rotor having therein the permanent magnet increases. In the motor-driven compressor wherein the resin film is flexible so as to adapt to the increasing volume of the rotor, the flexible resin film prevents the magnet powder from being released from the rotor. The flexibility of the resin film may be evaluated by elongation percentage determined by tensile test. The resin film having elongation percentage of 5% or more may be considered to be flexible.

The term “resin” as in the resin film is used herein in a broad sense, including natural resin, synthetic resin, natural rubber and synthetic rubber. The resin forming the film includes resin or rubber of, for example, polyethylene series, epoxy series, fluorine series, acrylic series, polyamide series, polyamide-imide series, silicone series, polyether ether ketone (PEEK) series, polyetherimide series, phenolic series, melamine series and urethane series. Of these resins, fluorine series resin is suitable for use because of its high flexibility.

In the motor-driven compressor of the present invention, it is preferred that the permanent magnet has thereon a protective film that improves corrosion resistance of the permanent magnet. The improved corrosion resistance of the permanent magnet further enhances the effect of preventing the deterioration of the permanent magnet.

In the motor-driven compressor of the present invention, it is preferred that at least part of a gap between the permanent magnet and a wall of the magnet hole is filled with fixing resin for fixing the permanent magnet to the wall of the magnet hole. That is, at least part of the gap between the permanent magnet and the wall of the magnet hole should be filled with the fixing resin only after the protective film is formed on the surface of the permanent magnet incorporated in the rotor. By so doing, if the permanent magnet in the rotor is urged to move relative to the rotor body while the motor-driven compressor is in operation, such relative movement is prevented by the fixing resin. Thus, the protective film of the surface of the permanent magnet is prevented from being damaged. Therefore, the deterioration of the permanent magnet is prevented further effectively.

In the motor-driven compressor of the present invention, it is preferred that the magnet hole has a main hole corresponding in shape to the contour of the permanent magnet and an expanded hole expanded outward from part of a wall of the main hole. It is also preferred that the expanded hole is opened at least at one end thereof in the axial direction of the rotor and filled with the fixing resin. In this case, the main hole of the magnet hole should be of a minimum required size, so that the filling of the fixing resin is concentrated in the expanded hole. Thus, the resin filling operation is facilitated while minimizing the deterioration of magnetic performance due to the formation of the expanded hole in the rotor for filling the fixing resin.

For the resin filling operation, a syringe-like resin filling device having a needle member with an injection hole at the distal end thereof may be used. The resin filling operation is accomplished by inserting the needle member into the expanded hole after inserting the permanent magnet into the magnet hole. The gap between the magnet hole and the permanent magnet may be filled at any position with the fixing resin without forming the expanded hole.

Various kinds of film may be used as the protective film to be formed on the surface of the permanent magnet as long as the protective film improves the corrosion resistance of the permanent magnet. The protective film formed on the surface of the permanent magnet may have a chemical adsorption film having at least one of hydroxy group and amino group.

The chemical adsorption film blocks the active spot from which the corrosion of the surface of the permanent magnet starts, thereby to prevent the development of the corrosion. In addition, the chemical adsorption film has an effect to neutralize acid by allowing alkaline functional group, such as hydroxy group or amino group of the chemical adsorption film, to react with acid. That is, the chemical adsorption film offers anti-corrosion and neutralizing effects. Thus, even if acid is present in the refrigerant circulation path, the permanent magnet having the chemical adsorption film is not prone to corrode and has high durability.

The chemical adsorption film can be easily made by allowing the permanent magnet having a desired shape to be in contact with the alkaline aqueous solution which contains amines and/or hydroxys and whose pH is 8 to 10, and then drying the film forming solution on the permanent magnet. That is, the resistance of the permanent magnet against acid corrosion is improved by allowing the permanent magnet to be in contact with the film forming solution and drying the film forming solution on the permanent magnet.

The chemical adsorption film is formed by chemical adsorption of amino group, hydroxy group or chemical compound containing amino group and hydroxy group on the surface of the permanent magnet. It is noted that the amino group may be defined as monovalent functional group (—NH₂, —NHR, —NRR′) wherein one or more hydrogen atoms are removed from ammonia, primary amine or secondary amine. This definition does not intend to restrict the material of the amino group but to provide the structure of the amino group. The amino group includes monovalent functional group obtained from tertiary amine.

The component of the chemical adsorption film depends on amines and/or hydroxys contained in film forming solution used in the film forming. The chemical adsorption film may have a composition of hydroxy group only, amino group only or both of hydroxy group and amino group.

The chemical adsorption film is formed of any one of the above functional groups or chemical compound having such functional group that is chemically adsorbed on a molecular level. Thus, the chemical adsorption film is extremely thin. The confirmation for the presence of the chemical adsorption film may be accomplished by performing method such as Raman spectroscopic analysis, infrared-ray spectroscopic analysis, or secondary ion mass spectrometry (SIMS) for confirming the presence of amino group or hydroxy group.

The protective film formed on the surface of the permanent magnet may have a film made of a metal. The metal for the protective film includes aluminum, nickel and copper. Known method such as plating, sputtering or evaporation may be used for forming a metal film. The corrosion resistance of the permanent magnet is improved remarkably by using a film made of a metal as the protective film. Film made only of a metal may be used as the protective film. Alternatively, the chemical adsorption film may be formed on the surface of the film made of a metal. In this case, the combined effects of the metal film and the chemical adsorption film synergistically enhance the corrosion resistance of the permanent magnet. To prevent the deterioration of the electric motor, a film made of a magnetic metal such as nickel is preferably used as the film made of a metal.

The protective film formed on the surface of the permanent magnet may have a film made of a resin. The resin for the film includes epoxy resin, acrylic resin and fluorine resin. The resin film may be formed by various coating methods. Using a film made of a resin as the protective film, hydrophobic surface that is prone to repel water may be easily formed. Although a film made only of a resin may be used as the protective film, the film made of a resin may be combined with the chemical adsorption film and/or the film made of a metal in a laminar form. For example, the chemical adsorption film may be formed on the surface of the resin film formed on the surface of the permanent magnet. Alternatively, the resin film may be formed on the surface of the metal film formed on the surface of the permanent magnet. In addition, the chemical adsorption film may be formed on the surface of such resin film. The use of a plurality of different films combined offers synergetic effect to further enhance the corrosion resistance of the permanent magnet.

The permanent magnet may be a rare-earth magnet. From the viewpoint of magnetic properties, the rare-earth magnet is more suitable than the ferrite magnet for use as the permanent magnet of the motor-driven compressor. On the other hand, however, the rare-earth magnet is more prone to corrode than the ferrite magnet. Therefore, it is particularly effective to form the rotor by the rotor body and the end plates disposed to close the magnet holes of the rotor body and then to cover the entire outer surface of the rotor with the resin film.

The motor-driven compressor is preferably used for a vehicle-mounted air conditioner having a refrigerant circulation path in which a nonmetallic duct is connected. The vehicle-mounted air conditioner includes a condenser, an expansion valve and an evaporator as well as the compressor that are connected by the refrigerant circulation path. The refrigerant circulation path is sealingly filled with refrigerant and lubricating oil. Nonmetallic duct such as resin duct may be used in part of the duct forming the refrigerant circulation path to impart the flexibility to the duct and to enhance the vibration-damping property. The term “resin” is used herein in a broad sense, including natural resin, synthetic resin, natural rubber and synthetic rubber. The nonmetallic duct such as resin duct is more prone to permit water permeation. If the nonmetallic duct is used for a long period of time in hot and humid conditions, water in the air may enter the refrigerant circulation path via the nonmetallic duct such as resin duct. Due to the ingress of water into the refrigerant circulation path, refrigerant and/or lubricating oil may change their properties thereby to produce acid. In the vehicle-mounted air conditioner, therefore, it is particularly effective to form the rotor by the rotor body and the end plates disposed to close the magnet holes of the rotor body and then to cover the entire outer surface of the rotor with the resin film.

The motor-driven compressor is preferably used in a refrigeration system through which the refrigerant that is expressed by molecular formula of C₃HₘFₙ having one double bond in a molecular structure of the molecular formula, where m is an integral number of 1 to 5, n is an integral number of 1 to 5, and m+n=6, or a mixed refrigerant containing such refrigerant circulates. There is a general trend that a refrigerant having less impact on the ozone layer than the refrigerant that has been referred to generally as chlorofluorocarbon has been used preferentially as the refrigerant for the refrigeration system. As such a new type of refrigerant, the refrigerant that is expressed by molecular formula of C₃HₘFₙ having one double bond in a molecular structure of the molecular formula, where m is an integral number of 1 to 5, n is an integral number of 1 to 5, and m+n=6, such as 2,3,3,3-tetrafluoroprop-1-ene (CF₃—CF═CH₂), has been attracting the attention from the industry. Such refrigerant is referred to as HFO1234yf type refrigerant.

The HFO1234yf type refrigerant is relatively prone to dissolve in the presence of water because it contains the double bond. If water is mixed with refrigerant in the refrigerant circulation path for any reason during the manufacturing process of the compressor or during the market use, the refrigerant may dissolve thereby to produce hydrofluoric acid (HF). Acid such as hydrofluoric acid causes the permanent magnet to corrode relatively early. In the refrigeration system using the HFO1234yf type refrigerant, therefore, it is particularly effective to form the rotor by the rotor body and the end plates disposed to close the magnet holes of the rotor body and then to cover the entire outer surface of the rotor with the resin film.

The motor-driven compressor is effective when the housing has therein lubricating oil containing at least one of polyolester (POE), polyvinyl ether (PVE) and polyalkylene glycol (PAG). The ingress of water or acid into the refrigerant circulation path is undesirable also in the case where the motor-driven compressor contains such lubricating oil in the housing. For example, polyolester hydrolyzes in the presence of water thereby to produce organic carboxylic acid. As in the case of the hydrofluoric acid, the organic carboxylic acid may cause the permanent magnet to corrode. Therefore, it is also particularly effective in this case to form the rotor by the rotor body and the end plates disposed to close the magnet holes of the rotor body and then to cover the entire outer surface of the rotor with the resin film.

The resin film does not necessarily have to coat the entire outer surface of the rotor.

What is claimed is:

1. A motor-driven compressor comprising:
a housing having a suction port and a discharge port;
a compression mechanism disposed in the housing, the compression mechanism being adapted to compress refrigerant drawn into the housing through the suction port and to discharge the compressed refrigerant out of the housing through the discharge port;
a rotary shaft disposed in the housing;
an electric motor disposed in the housing, the electric motor being adapted to rotate the rotary shaft to drive the compression mechanism, the electric motor having a rotor fixed on the rotary shaft and a stator supported by the housing, the rotor having a rotor body, a permanent magnet and an end plate, the rotor body having a magnet hole in which the permanent magnet is inserted, the end plate closing an opening of the magnet hole; and
a resin film coating an outer surface of the rotor.

2. The motor-driven compressor according to claim 1, wherein the resin film coats boundary between the rotor and the rotary shaft.

3. The motor-driven compressor according to claim 1, wherein the resin film is flexible.

4. The motor-driven compressor according to claim 1, wherein the permanent magnet has on a surface a protective film that improves corrosion resistance of the permanent magnet.

5. The motor-driven compressor according to claim 4, wherein at least part of a gap between the permanent magnet and a wall of the magnet hole is filled with fixing resin for fixing the permanent magnet to the wall of the magnet hole.

6. The motor-driven compressor according to claim 4, wherein the magnet hole has a main hole corresponding in shape to a contour of the permanent magnet and an expanded hole expanded outward from part of a wall of the main hole, wherein the expanded hole is opened at least at one end in an axial direction of the rotor and filled with the fixing resin.

7. The motor-driven compressor according to claim 4, wherein the protective film formed on the surface of the permanent magnet has a chemical adsorption film having at least one of hydroxy group and amino group.

8. The motor-driven compressor according to claim 4, wherein the protective film formed on the surface of the permanent magnet has a film made of a metal.

9. The motor-driven compressor according to claim 4, wherein the protective film formed on the surface of the permanent magnet has a film made of a resin.

10. The motor-driven compressor according to claim 1, wherein the permanent magnet is a rare-earth magnet.

11. The motor-driven compressor according to claim 1, wherein the motor-driven compressor is used for a vehicle-mounted air conditioner having a refrigerant circulation path in which a nonmetallic duct is connected.

12. The motor-driven compressor according to claim 1, wherein the motor-driven compressor is used in a refrigeration system through which the refrigerant that is expressed by molecular formula of C₃HₘFₙ having one double bond in a molecular structure of the molecular formula, wherein m is an integral number of 1 to 5, n is an integral number of 1 to 5, and m+n=6, or a mixed refrigerant containing the refrigerant circulates.

13. The motor-driven compressor according to claim 1, wherein the housing has lubricating oil containing at least one of polyolester (POE), polyvinyl ether (PVE) and polyalkylene glycol (PAG).
